(19) United States
(12) Patent Application Publication
(10) Pub. No.: US 2009/0260736 A1
(43) Pub. Date: Oct. 22, 2009

(54) Method and apparatus for encapsulating wire, hose, and tube splices, connections, and repairs

(76) Inventor: Steven Michael Charette, Frankenmuth, MI (US)

Correspondence Address: STEVEN M. CHARETTE, 1485 S. DEHMEL RD., FRANKENMUTH, MI, 48734, US

(21) Appl. No.: 12/386,132

(22) Filed: Apr. 14, 2009

Related U.S. Application Data
(60) Provisional application No. 61/044,982, filed on Apr. 15, 2008.

(51) Int. Cl. H02G 1/14; B29C 45/14

(52) U.S. Cl. 156/49; 425/542; 156/502

(57) ABSTRACT

An improved method and apparatus for encapsulation of splices, connections, and repairs of wires, tubes, hoses, and similar conductors. Encapsulation is accomplished by securing the area to be encapsulated in a mold set and injecting a hot-melt sealant. Further embodiments allow for the addition of mounting lugs or tabs to the encapsulation for the purpose of mounting or identification. Method can also be used to mold mounting lugs or identification tabs over uninterrupted portions of the aforementioned conductors. The method provides superior resistance to ingress of contaminants and provides strain relief of encapsulated areas by supporting the conductors to reduce movement. The adhesive nature of the sealant reduces the likelihood of conductors being pulled apart.

### CROSS-REFERENCE TO RELATED APPLICATIONS

This application claims the benefit of provisional patent application Ser. No. 61/044,982, EFS ID 3153640 filed 2008, Apr. 15 by the present inventor.

### FEDERALLY SPONSORED RESEARCH

Not Applicable

### SEQUENCE LISTING OR PROGRAM

Not Applicable

### BACKGROUND

1. Field

This application relates to encapsulation of splices, connections, and repairs of wire, hose and tube.

2. Prior Art

Electrical wiring splices often fail due to corrosion as a result of exposure of the metal portions of the splice to contaminants.

Several types of sealing methods have been patented for the encapsulation of these types of splices. U.S. Pat. No. 4,634,615 to Versteegh depicts a heat shrinkable tubing that can be placed over a splice in its expanded state, then be shrunk tight to the splice using heat. A further development of the heat shrink material is defined in U.S. Pat. No. 4,915,139 to Landry, where the tubing lined with an adhesive that melts when heated, providing additional sealing. Directions for use call for the use of a heat gun with special fitments specifically designed for heat shrinking of the aforementioned tubing, but in actual practice the tubing is often shrunk using a cigarette lighter, match or torch, or a heat gun without the proper attachments. While this method can provide a weathertight seal in the adhesive lined version, the heat applied can easily damage surrounding materials and potentially cause fire, even if the specialized heat gun is used. In addition, the finished result is often unsightly due to inconsistent application of heat, shape of the splice being sealed (in the event of a soldered joint) or burning.

U.S. Pat. No. 4,151,364 to Ellis discloses a splice with an integral heat shrink covering, which is more convenient than applying separate heat shrink tube, but is significantly more expensive than applying the materials as described in the paragraph above. Heat damage and the potential for fire also exist using this method.

In another method defined in U.S. Pat. No. 5,422,438 to Lamome, splice connectors are supplied packed with a sealant gel that encapsulates the splice when crimped. While this type of splice does not require the application of heat, they can be messy to use and are much more expensive than aforementioned designs.

Other methods require wrapping or encasing the conductors in a substrate sealed to the conductors before the addition of a sealing media as described in U.S. Pat. No. 4,875,952 to Mullin and Reed.

Still another process utilizes complex shuttle molds to encapsulate high tension wires as defined in U.S. Pat. No. 3,142,716 to Gardner.

The following methods, while probably suitable for larger conductors, are not well suited for smaller applications where simplicity, aesthetics, time, and cost are of the essence. U.S. Pat. No. 2,536,173 to Hamilton defines a method of vulcanizing suitable materials over cable splices. U.S. Pat. No. 2,161,447 to Bishop describes a method of sealing larger splices by the layering of insulating materials and then a covering the splice with a protective shell. Earlier U.S. Pat. Nos. 2,059,055 and 2,122,118 to Studt describe the hand application of insulating materials for submarine cables.

### ADVANTAGES

Thus several advantages of one or more aspects are to provide a more weather resistant seal, with increased joint integrity. Other advantages of one or more aspects are lower cost, improved aesthetics, and ease of use. These and other advantages of one or more aspects will become apparent from a consideration of the ensuing description and accompanying drawings.

### SUMMARY

In accordance with one embodiment a wire connection is placed in a mold base, the mold is closed with the mold cover and the mold assembly is secured. A hot-melt sealant is injected through one or more injection ports and the sealant is allowed to cool. The sealed connection is then removed from the mold, cleaned, inspected, and placed in service.

### DRAWINGS

FIG. 1 shows the mold apparatus in accordance with the preferred embodiment.

FIGS. 2A to 2G show sequential steps of the process in accordance with the preferred embodiment.

FIG. 3 shows a similar implementation featuring multiple conductors.

FIG. 4 shows another implementation utilizing an insulation displacement connector.

FIG. 5 shows another implementation utilizing a ring tongue connector.

FIG. 6 shows another implementation utilizing a wire nut.

FIG. 7 shows a modification of the embodiment illustrated in FIG. 1 which incorporates a mounting tab or lug to allow the encapsulation to be mounted with a fastener or tie-wrap.

FIG. 8 shows a modification of the embodiment illustrated in FIG. 1 which incorporates a flag or tab which can be marked, labeled, embossed, cut, or punched for the purposes of identification.

FIG. 9A shows another embodiment whereby a mounting tab or lug is applied to the conductor utilizing the method illustrated in FIG. 2 which allows the conductor to be mounted with a fastener or tie-wrap.

FIG. 9B shows another embodiment whereby a flag or tab is applied to the conductor which can be marked, labeled, embossed, cut, or punched for the purposes of identification.

### REFERENCE NUMERALS

10—mold base 16—injection port
11—mold cover 17—prepared splice
12—conductor grooves 18—encapsulated splice
13—mold cavity 19—clamp
14—alignment pin 20—sealant injection gun
15—alignment pin hole

### DETAILED DESCRIPTION

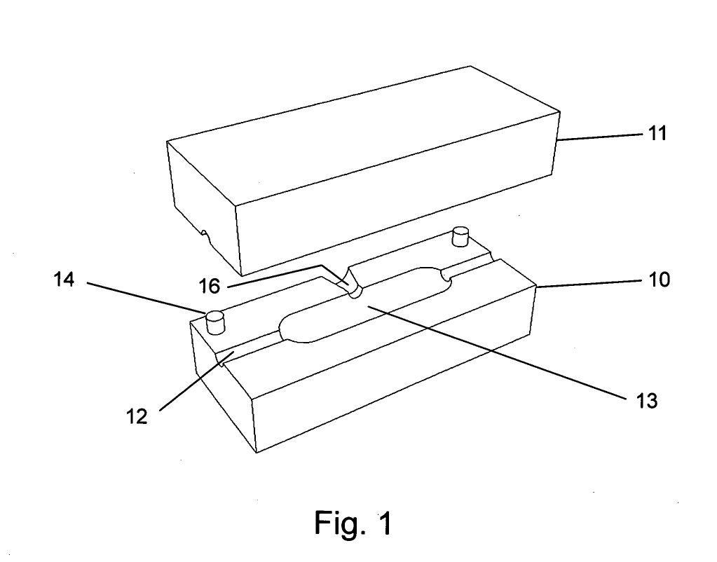

### FIG. 1—First Embodiment

One embodiment of the invention is illustrated in FIG. 1. The apparatus consists of two mold halves, mold base 10 and mold cover 11. Mold halves are constructed of aluminum or other heat resistant material. The mold halves feature close fitting apertures or grooves 12 allowing a prepared splice assembly 17 being encapsulated passage into the mold cavity 13. The mold halves feature alignment pins 14 for precise alignment of the mold halves, and may or may not have a hinge, latching device, or other alignment aids. The mold cavity 13 is of the appropriate size and shape for the conductor and splice type being encapsulated (i.e. butt splice, crimp cap, terminal, etc.). The mold assembly can have one or more apertures, grooves or openings at each end, one or more openings on adjacent sides, or no openings on one or more sides for conductors so oriented. FIG. 1 shows a perspective view of this embodiment containing the mold base 10 shown with alignment pins 14, and the mold cover 11. Alignment pin holes 15 in cover 11 not visible in this view.

### OPERATION

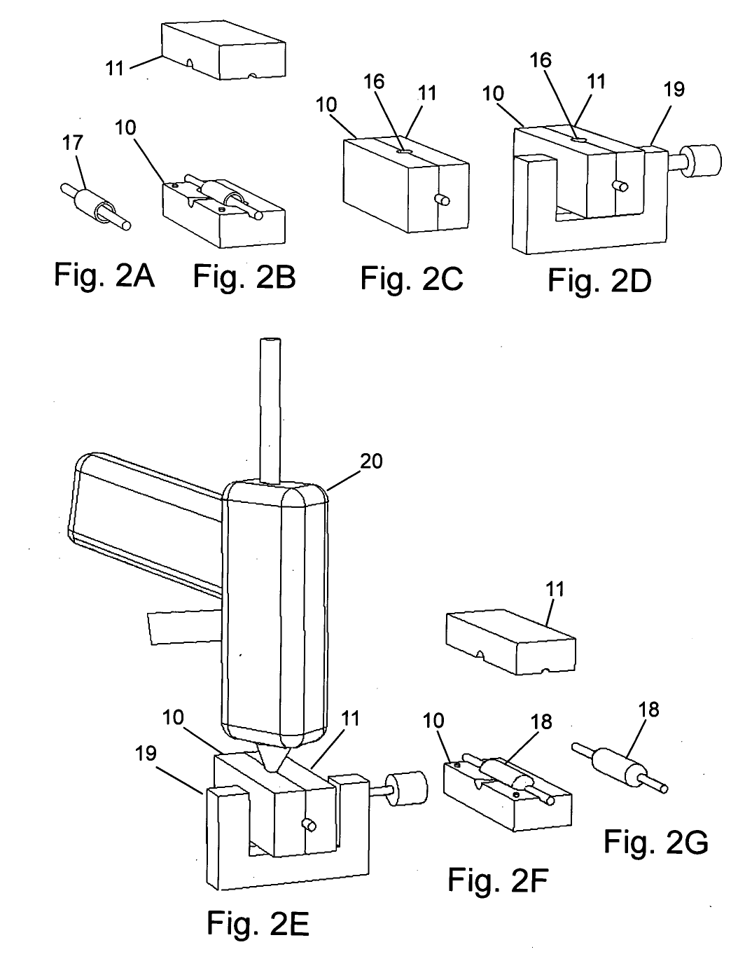

### First Embodiment—FIGS. 2A to 2G

The operation of this embodiment is illustrated in FIGS. 2A to 2G. FIG. 2A shows the prepared splice 17, in this case an insulated crimp-style butt splice, ready for placement into the mold base 10. FIG. 2B shows said splice 17 placed in mold base 10. FIG. 2C shows mold cover 11 in place over mold base 10 with splice 17 centrally located within the mold cavity 13. The mold halves 10 and 11 are secured with a clamp 19 or other suitable holding means as shown in FIG. 2D to prevent separation of the halves during the molding process. Sealant is injected through the injection port with sealant injection gun 20, FIG. 2E. The sealant is allowed to cool, the clamping device 19 is removed, mold cover 11 is removed from mold base 10 (FIG. 2F) and the encapsulated splice 18 is removed from the mold, FIG. 2G.

### DESCRIPTION

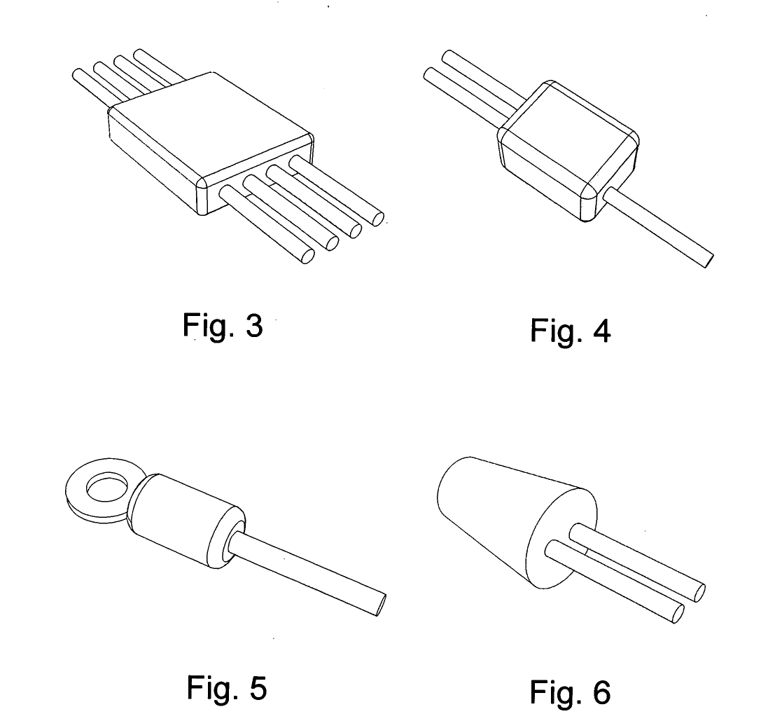

### Additional Embodiment—FIGS. 3, 4, 5, 6, 7, 8, 9A, 9B

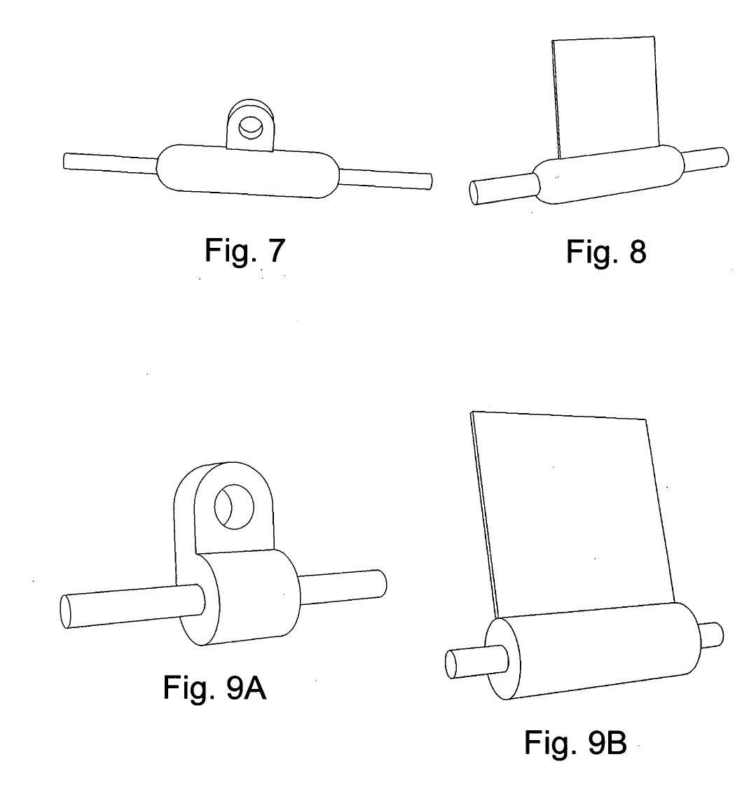

Additional embodiments allow the encapsulation of multiple connectors (FIG. 3) as well as specialized connectors such as insulation displacement connectors, ring tongue connectors, and wire nuts (FIGS. 4, 5, 6). Mounting lugs and identification tabs can be molded in either over a connection (FIGS. 7, 8), or simply over an uninterrupted section of conductor (FIGS. 9A, 9B).

### OPERATION

### Additional Embodiment

Operation of additional embodiments is essentially similar to the operation of the first embodiment. In some cases sealant will be injected through more than one port to fully encapsulate the connection or the mold may have one or more posts, inserts, slides or other details to accommodate features specific to the conductor being encapsulated. Molds can be one piece, or two or more pieces. Additional sprue or gate passages can be added for more complicated forms.

### CONCLUSIONS, RAMIFICATIONS, AND SCOPE

Thus the reader will see that in at least one embodiment splices, connections and repairs can easily and economically be encapsulated to provide superior joint integrity in various applications and circumstances.

While the above description contains many specificities, these should not be construed as limitations of scope, but rather as an exemplification of one (or several) preferred embodiment(s) thereof. Many other variations are possible. For example, long conductors as found on trailers, busses, or large boats can be identified by the addition of a colored mounting lug or identification tab. Sound system speaker wire connections can be color coded for ease of installation and repair. Hose or tube connections can be encapsulated providing not only an improved seal, but also increased resistance to joint separation. Encapsulation of splices reduces the likelihood of tampering and provides a visual clue if a splice or joint has been compromised. Removable connectors such as slide or bullet connectors can be encapsulated with additional material over exposed metal portions for improved insulation and safety. The molded capsule can provide improved grip in applications where size or environment make handling difficult. Sealant guns are available in many configurations, such as different voltages so that they can be powered by available voltages at a given worksite, or from a vehicle. Butane, cordless or battery powered sealant guns can be used in remote locations or in applications where a corded sealant gun is not practical. Specialized clamping devices can be used in limited space applications, or where speed is important to the operation.

Accordingly, the scope should be determined not by the embodiment(s) illustrated, but by the appended claims and their legal equivalents.

I claim:

1. A method, comprising:
a mold with a cavity of the appropriate size and shape to contain a splice, connection, or repair being encapsulated, said mold having one or more grooves to allow passage of one or more wires, hoses or other conductors into said cavity, and one or more openings for the introduction of a hot-melt sealant; and
said hot melt sealant; and
means to melt and inject said hot melt sealant into the mold, whereby the splice, connection, or repair can be encapsulated quickly and easily.

2. The mold of claim 1 wherein said cavity also forms a mounting lug on said encapsulation.

3. The mold of claim 1, wherein said cavity also forms a flag or tab.

4. A method, comprising:
a mold with a cavity of the appropriate size and shape to contain a wire, tube or other conductor, said mold having one or more grooves to allow passage of one or more conductors into said cavity; said cavity having the appropriate features to form a mounting lug and or a flag or tab, and one or more openings for the introduction of a hot-melt sealant; and
said hot melt sealant; and
means to melt and inject said hot melt sealant into the mold, whereby the conductor can be anchored or labeled quickly and easily.
